(19) United States
(12) Patent Application Publication
(10) Pub. No.: US 2025/0337312 A1
(43) Pub. Date: Oct. 30, 2025

(54) PULSE WIDTH MODULATION POWER SUPPLY METHOD, AND ELECTRONIC HIGH-VOLTAGE ENERGY EXTRACTION AND SAMPLING APPARATUS AND METHOD

(71) Applicants: ELECTRIC POWER RESEARCH INSTITUTE, CHINA SOUTHERN POWER GRID, Guangzhou, Guangdong (CN); SHENZHEN POWER SUPPLY CO., LTD., Shenzhen, Guangdong (CN)

(72) Inventors: Xuntao SHI, Guangzhou, Guangdong (CN); Xiaobing XIAO, Guangzhou, Guangdong (CN); Jian SUN, Guangzhou, Guangdong (CN); Qingpai KE, Guangzhou, Guangdong (CN); Yangxin QIU, Guangzhou, Guangdong (CN); Tong LIU, Guangzhou, Guangdong (CN); Min XU, Guangzhou, Guangdong (CN); Zhiyong YUAN, Guangzhou, Guangdong (CN); Jinyong LEI, Guangzhou, Guangdong (CN); Lei YU, Guangzhou, Guangdong (CN); Hao BAI, Guangzhou, Guangdong (CN); Ran HU, Shenzhen, Guangdong (CN); Bing LI, Shenzhen, Guangdong (CN); Hong XIE, Shenzhen, Guangdong (CN); Kairan LI, Guangzhou, Guangdong (CN)

(73) Assignees: ELECTRIC POWER RESEARCH INSTITUTE, CHINA SOUTHERN POWER GRID, Guangzhou, Guangdong (CN); SHENZHEN POWER SUPPLY CO., LTD., Shenzhen, Guangdong (CN)

(21) Appl. No.: 18/860,724

(22) PCT Filed: Jun. 22, 2022
(86) PCT No.: PCT/CN2022/100360

§ 371 Date: Oct. 28, 2024

(30) Foreign Application Priority Data
May 24, 2022 (CN) 202210570071.X

(51) Int. Cl. H02M 1/00; H02M 1/08; H02M 3/155; H02M 7/06

(52) U.S. Cl. CPC H02M 1/0048; H02M 1/08; H02M 3/155; H02M 7/06

(57) ABSTRACT

A pulse width modulation power supply method, and an electronic high-voltage energy extraction and sampling apparatus and method. The apparatus uses a high-voltage energy extraction module composed of a high voltage-side element and a low voltage-side element, so that the electronic high-voltage energy extraction and sampling apparatus can achieve the purpose of high-efficiency voltage energy extraction, and implement the characteristics of high power factor and high conversion efficiency. A waveform characteristic of a voltage of a high-voltage power supply is indirectly reflected by means of a current in the low voltage-side element of a low-voltage arm, so that the purpose of monitoring the voltage of the high-voltage power supply is achieved.

This application claims the priority to Chinese patent application No. 202210570071.X, titled “POWER SUPPLY METHOD BY PULSE WIDTH MODULATION, AND ELECTRONIC HIGH-VOLTAGE ENERGY EXTRACTION AND SAMPLING DEVICE AND METHOD”, filed on May 24, 2022 with the China National Intellectual Property Administration, which is incorporated herein by reference in its entirety.

### FIELD

The present disclosure relates to the technical field of high-voltage energy extraction, and in particular to a power supply method by pulse width modulation, and an electronic high-voltage energy extraction and sampling device and method.

### BACKGROUND

In a power distribution network, a pole-mounted switch and a ring main unit each are not externally connected to a low-voltage alternating-current power supply, and are self-powered with high-voltage electrical energy. Commonly, the self-powered mode with high-voltage electrical energy is implemented by a voltage transformer, where the transformer is used to isolate a high-voltage system to ensure safety of people and devices.

In various high-voltage application scenarios, such as the outdoor pole-mounted switch, an outdoor transformer, an indoor ring main unit, and an indoor switch cabinet, a high-voltage signal is to be sampled for voltage detection, electricity metering and relay protection. In addition, it is required to meet a demand for low-voltage power consumption of a secondary intelligent device, and to ensure that an electronic component such as an outdoor sensor, operates normally.

A conventional electromagnetic voltage transformer is able to transform a high voltage to a low voltage for detecting or protecting a system. However, the electromagnetic voltage transducer is bulky, expensive, and inconvenient to install. Additionally, ferromagnetic resonance may occur if a large number of the electromagnetic voltage transformers are used in the system of the power distribution network. An electronic voltage transformer is small in size and low in power consumption, and avoids the ferromagnetic resonance. In addition, a resistive divider voltage transformer is not suitable for energy extraction under high power and high voltage due to a large amount of power loss and serious heating. Comparing with the electromagnetic voltage transformer, a capacitive voltage transformer is smaller in size and is more economical. However, the capacitive voltage transformer has small energy extraction power and low efficiency, and thus is currently applied in a low-power secondary device such as the pole-mounted switch. A transformer component is still retained in a conventional capacitive energy extraction device, and consequently the conventional capacitive energy extraction device has a low power factor and high harmonic content. Further, a transformer for energy extraction fails to acquire the high-voltage signal.

### SUMMARY

A power supply method by pulse width modulation and an electronic high-voltage energy extraction and sampling device and method are provided according to embodiments of the present disclosure, to solve a technical problem of a low power factor, low conversion efficiency, a complicated circuit structure and a large size of the conventional high-voltage energy extraction element.

In order to achieve the above objectives, the following technical solutions are provided according to the embodiments of the present disclosure.

An electronic high-voltage energy extraction and sampling device includes a high-voltage power supply, a high-voltage energy extraction module connected to the high-voltage power supply, a rectification module connected to the high-voltage energy extraction module, and a stabilization output module connected to the rectification module. The stabilization output module is connected to a load. The high-voltage energy extraction module includes a high-voltage side element and a low-voltage side element. The high-voltage power supply is configured to provide a high-voltage alternating-current source. The high-voltage side element is connected in series with the high-voltage power supply to form a high-voltage arm. The low-voltage side element is connected in series with the high-voltage side element to form a low-voltage arm. The rectification module is connected to the low-voltage side element and is configured to rectify power outputted from the low-voltage side element. The stabilization output module is configured to supply stable direct-current power to the load.

In an embodiment, the stabilization output module includes a switching element, a voltage stabilizing element, a feedback element, and a pulse width controller. The switching element includes a first connection terminal, a second connection terminal, and a third connection terminal. The first connection terminal and the second connection terminal of the switching element are connected in parallel with an output end of the rectification module, the third connection terminal of the switching element is connected to an output terminal of the pulse width controller, and the first connection terminal of the switching element is further connected to a first terminal of the voltage stabilizing element. A second terminal of the voltage stabilizing element is connected to a first terminal of the feedback element, a first input terminal of the pulse width controller and the load, and a second terminal of the feedback element is grounded. A second input terminal of the pulse width controller is connected to a signal supply module, and the pulse width controller is configured to modulate a pulse width of current outputted from the voltage stabilizing element based on a duty ratio of a pulse-width signal outputted from the pulse width controller, to supply the stable direct-current power to the load.

In an embodiment, the pulse width controller is configured to: increase the duty ratio of the pulse-width signal outputted from the pulse width controller if a voltage outputted from the feedback element is greater than a rated voltage threshold, or decrease the duty ratio of the pulse-width signal outputted from the pulse width controller if the voltage outputted from the feedback element is less than the rated voltage threshold.

In an embodiment, the high-voltage energy extraction module is connected to a connection terminal of the high-voltage alternating-current source of each phase provided by the high-voltage power supply.

In an embodiment, the electronic high-voltage energy extraction and sampling device includes a current sampling module, configured to sample a current at an output end of the high-voltage energy extraction module.

In an embodiment, the high-voltage side element includes a high-voltage capacitor and the low-voltage side element includes a low-voltage inductor.

A power supply method by pulse width modulation is further provided according to the present disclosure, applied to the electronic high-voltage energy extraction and sampling device described above. The power supply method by pulse width modulation includes: obtaining a rated voltage threshold required by the load and a voltage outputted from the feedback element; increasing the duty ratio of the pulse-width signal outputted from the pulse width controller if the voltage outputted from the feedback element is greater than the rated voltage threshold, or decreasing the duty ratio of the pulse-width signal outputted from the pulse width controller if the voltage outputted from the feedback element is less than the rated voltage threshold; and modulating a pulse width of current outputted from the voltage stabilizing element based on the duty ratio of the pulse width-signal, to supply stable direct-current power to the load.

In an embodiment, the modulating a pulse width of current outputted from the voltage stabilizing element based on the duty ratio of the pulse width-signal includes: increasing a duration for which a switching element is switched on and decreasing the pulse width of the current outputted from the voltage stabilizing element, i.e., decreasing an average current outputted from the voltage stabilizing element to decrease a voltage of the direct-current voltage supplied to the load, if the duty ratio of the pulse-width signal outputted from the pulse width controller is increased; and decreasing the duration for which the switching element is switched on and increasing the pulse width of the current outputted from the voltage stabilizing element, i.e., increasing the average current outputted from the voltage stabilizing element to increase the voltage of the direct-current power supplied to the load, if the duty ratio of the pulse-width signal outputted from the pulse width controller is decreased.

An electronic high-voltage energy extraction and sampling method is further provided according to present disclosure, including: obtaining, by the electronic high-voltage energy extraction and sampling device described above, a capacitance value of the low-voltage side element and a current outputted from the low-voltage side element; and calculating a voltage of a high-voltage alternating-current source in a phase corresponding to the low-voltage side element from the capacitance value of the low-voltage side element and the current outputted from the low-voltage side element.

In an embodiment, the calculating a voltage of a high-voltage alternating-current source in a phase corresponding to the low-voltage side element from the capacitance value of the low-voltage side element and the current outputted from the low-voltage side element includes: calculating the voltage of the high-voltage alternating-current source in the phase corresponding to the low-voltage side element from the capacitance value of the low-voltage side element and the current outputted from the low-voltage side element based on a proportional integral equation, where the proportional integral equation is expressed as: U=∫I_{dt}/C, where I represents the current outputted from the low-voltage side element, U represents the voltage of the high-voltage alternating-current source in the phase corresponding to the low-voltage side element, and C represents the capacitance value of the low-voltage side element.

According to the above technical solutions, the embodiments of the present disclosure have following technical benefits. The power supply method by pulse width modulation, and the electronic high-voltage energy extraction and sampling device and method are provided. The device includes the high-voltage power supply, the high-voltage energy extraction module connected to the high-voltage power supply, the rectification module connected to the high-voltage energy extraction module, and the stabilization output module connected to the rectification module. The stabilization output module is connected to the load. The high-voltage energy extraction module includes the high-voltage side element and the low-voltage side element. The high-voltage power supply is configured to provide the high-voltage alternating-current source. The high-voltage side element is connected in series with the high-voltage power supply to form the high-voltage arm. The low-voltage side element is connected in series with the high-voltage side element to form the low-voltage arm. The rectification module is connected to the low-voltage side element and is configured to rectify power outputted from the low-voltage side element. The stabilization output module is configured to supply stable direct-current power to the load. In the electronic high-voltage energy extraction and sampling device, the high-voltage energy extraction module is formed by the high-voltage side element and the low-voltage side element, so that the electronic high-voltage energy extraction and sampling device can extract energy efficiently and have a high power factor and high conversion efficiency. A waveform characteristic regarding to a voltage of the high-voltage power supply is indirectly reflected by current flowing through the low-voltage side element of the low-voltage arm, thereby monitoring the voltage of the high-voltage power supply. The electronic high-voltage energy extraction and sampling device has a simple circuit structure, and thus has a small size, so that the electronic high-voltage energy extraction and sampling device can be applied in scenarios with a narrow space. In addition, the electronic high-voltage energy extraction and sampling device can achieve the high-voltage energy extraction and voltage monitoring, solving the technical problem of a low power factor, low conversion efficiency, a complicated circuit structure, and a large size of the conventional high-voltage energy extraction element.

### BRIEF DESCRIPTION OF THE DRAWINGS

In order to more clearly illustrate the technical solutions in the embodiments of the present disclosure or in conventional technology, the drawings to be used in description of the embodiments or the conventional technology are briefly introduced hereinafter. Obviously, the drawings in the following description are only some embodiments of the present disclosure. For those skilled in the art, other drawings may also be obtained from these drawings without any creative work.

FIG. 1 is a schematic block diagram of an electronic high-voltage energy extraction and sampling device according to an embodiment of the present disclosure;

FIG. 2 is a schematic circuit diagram of an electronic high-voltage energy extraction and sampling device according to an embodiment of the present disclosure;

FIG. 3 is a diagram showing startup waveforms of currents of low-voltage inductors and an outputted direct-current voltage Vout in an electronic high-voltage energy extraction and sampling device according to an embodiment of the present disclosure;

FIG. 4 is a diagram showing signal waveforms of switching elements in an electronic high-voltage energy extraction and sampling device according to an embodiment of the present disclosure; and

FIG. 5 is a flowchart showing an electronic high-voltage energy extraction and sampling method according to an embodiment of the present disclosure.

### DETAILED DESCRIPTION OF THE EMBODIMENTS

In order to make the purpose, features and advantages of the present disclosure more clear and understandable, the technical solutions in the embodiments of the present disclosure are clearly and completely described below in conjunction with the drawings of the embodiments of the present disclosure. Apparently, the following described embodiments are only some, but not all, of the embodiments of the present disclosure. Based on the embodiments of the present disclosure, all of the other embodiments which are obtained by those skilled in the art without any creative work fall within the protection scope of the present disclosure.

A power supply method by pulse width modulation and an electronic high-voltage energy extraction and sampling device and method are provided according to the embodiments of the present disclosure, to solve a technical problem of a low power factor, low conversion efficiency, a complicated circuit structure, and a large size of the conventional high-voltage energy extraction element.

### First Embodiment

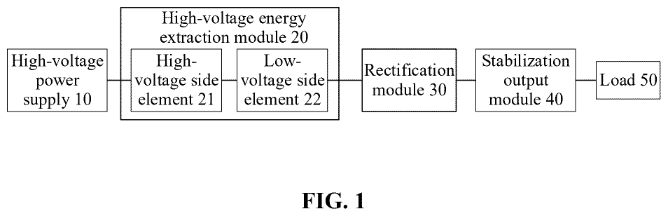

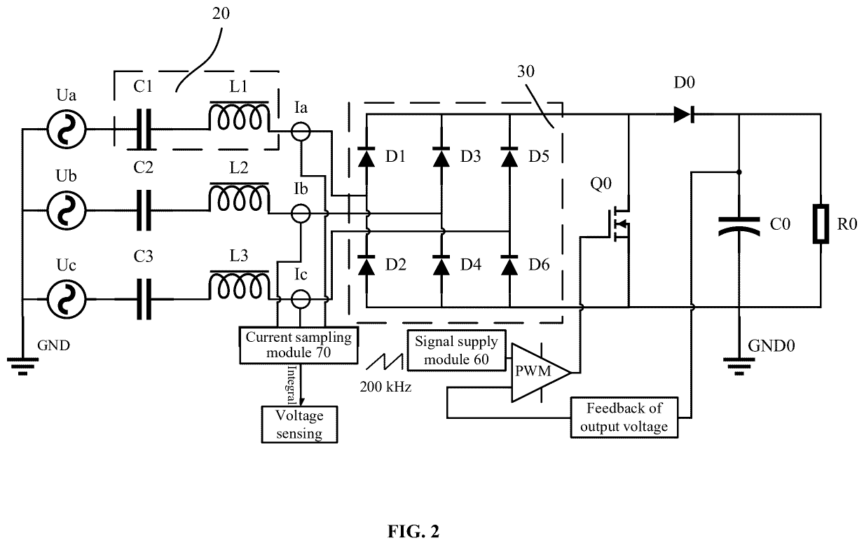

FIG. 1 is a schematic block diagram of an electronic high-voltage energy extraction and sampling device according to an embodiment of the present disclosure. FIG. 2 is a schematic circuit diagram of an electronic high-voltage energy extraction and sampling device according to an embodiment of the present disclosure.

As shown in FIG. 1 and FIG. 2, in an embodiment of the present disclosure, the electronic high-voltage energy extraction and sampling device according to the present disclosure includes a high-voltage power supply 10, a high-voltage energy extraction module 20 connected to the high-voltage power supply 10, a rectification module 30 connected to the high-voltage energy extraction module 20, and a stabilization output module 40 connected to the rectification module 30. The stabilization output module 40 is connected to a load 50. The high-voltage energy extraction module 20 includes a high-voltage side element 21 and a low-voltage side element 22.

In the embodiment of the present disclosure, the high-voltage power supply 10 is configured to provide a high-voltage alternating-current source. In the embodiment, the high-voltage alternating-current source provided by the high-voltage power supply 10 may be high-voltage alternating-current source of single phase, high-voltage alternating-current sources of two phases, or high-voltage alternating-current sources of three phases. A connection terminal of the high-voltage alternating-current source of each phase provided by the high-voltage power supply 10 is connected to the high-voltage energy extraction module 20. In the embodiment, as shown in FIG. 2, the high-voltage power supply 10 includes high-voltage alternating-current sources of three phases, i.e., Ua, Ub, and Uc. A first terminal of the high-voltage power supply 10 is grounded, and connection terminals of the high-voltage alternating-current sources provided by the high-voltage power supply 10 are connected to respective high-voltage energy extraction modules 20.

In the embodiment of the present disclosure, the high-voltage side element 21 is connected in series with the high-voltage power supply 10 to form a high-voltage arm. The low-voltage side element 22 is connected in series with the high-voltage side element 21 to form a low-voltage arm.

It should be noted that the high-voltage side element 21 may be a high-voltage capacitor, and the low-voltage side element 22 may be a low-voltage inductor. In the embodiment, as shown in FIG. 2, the high-voltage alternating-current source Ua provided by the high-voltage power supply is connected in series with a high-voltage capacitor C1 to form the high-voltage arm, and the high-voltage capacitor C1 is connected in series with a low-voltage inductor L1 to form the low-voltage arm. The high-voltage alternating-current source Ub provided by the high-voltage power supply is connected in series with a high-voltage capacitor C2 to form the high-voltage arm, and the high-voltage capacitor C2 is connected in series with a low-voltage inductor L2 to form the low-voltage arm. The high-voltage alternating-current source Uc provided by the high-voltage power supply is connected in series with a high-voltage capacitor C3 to form the high-voltage arm, and the high-voltage capacitor C3 is connected in series with a low-voltage inductor L3 to form the low-voltage arm.

In the embodiment of the present disclosure, the rectification module 30 is connected to the low-voltage side element 22 and is configured to rectify power outputted from the low-voltage side element 22.

It should be noted that the rectification module 30 is configured to rectify the alternating-current power outputted from the low-voltage side element 22 into direct-current power. In the embodiment, the rectification module 30 may be a rectifier bridge. As shown in FIG. 2, the low-voltage inductors L1, L2, and L3 of three phases are connected to an input end of the rectifier bridge formed by diodes D1 to D6 of three phases to form a three-phase rectifier circuit.

In the embodiment of the present disclosure, the stabilization output module 40 is configured to supply stable direct-current power to the load 50.

It should be noted that the stabilization output module 40 may stabilize and modulate the direct-current power outputted from the rectification module 30 and supply suitable direct-current power to the load 50. In the embodiment, as shown in FIG. 2, the load 50 is represented by a load resistor R0.

The electronic high-voltage energy extraction and sampling device in the present disclosure includes the high-voltage power supply, the high-voltage energy extraction module connected to the high-voltage power supply, the rectification module connected to the high-voltage energy extraction module, and the stabilization output module connected to the rectification module. The stabilization output module is connected to the load. The high-voltage energy extraction module includes the high-voltage side element and the low-voltage side element. The high-voltage side element is connected in series with the high-voltage power supply to form the high-voltage arm. The low-voltage side element is connected in series with the high-voltage side element to form the low-voltage arm. The rectification module is connected to the low-voltage side element and is configured to rectify power outputted from the low-voltage side element. The stabilization output module is configured to supply stable direct-current power to the load. In the electronic high-voltage energy extraction and sampling device, the high-voltage energy extraction module is formed by the high-voltage side element and the low-voltage side element, so that the electronic high-voltage energy extraction and sampling device can extract energy efficiently and have a high power factor and high conversion efficiency. A waveform characteristic regarding to a voltage of the high-voltage power supply is indirectly reflected by current flowing through the low-voltage side element of the low-voltage arm, thereby monitoring the voltage of the high-voltage power supply. The electronic high-voltage energy extraction and sampling device has a simple circuit structure, and thus has a small size, so that the electronic high-voltage energy extraction and sampling device can be applied in scenarios with a narrow space. In addition, the electronic high-voltage energy extraction and sampling device can achieve the high-voltage energy extraction and voltage monitoring, solving the technical problem of a low power factor, low conversion efficiency, a complicated circuit structure, and a large size of the conventional high-voltage energy extraction element.

As shown in FIG. 2, in an embodiment of the present disclosure, the stabilization output module 40 includes a switching element Q0, a voltage stabilizing element D0, a feedback element C0, and a pulse width controller PWM. The switching element Q0 includes a first connection terminal, a second connection terminal and a third connection terminal. The first connection terminal and the second connection terminal of the switching element Q0 are connected in parallel with an output end of the rectification module 60, and the third connection terminal of the switching element Q0 is connected to an output terminal of the pulse width controller PWM. The first connection terminal of the switching element Q0 is further connected to a first terminal of the voltage stabilizing element D0. A second terminal of the voltage stabilizing element D0 is connected to a first terminal of the feedback element C0, a first input terminal of the pulse width controller PWM and the load 50. A second terminal of the feedback element C0 is grounded. A second input terminal of the pulse width controller PWM is connected to a signal supply module 60. The pulse width controller PWM is configured to modulate a pulse width of current outputted from the voltage stabilizing element D0 based on a duty ratio of a pulse-width signal outputted from the pulse width controller PWM, so as to supply stable direct-current power to the load 50.

It should be noted that the switching element Q0 may be a field effect transistor such as a MOS transistor, a triode, or an IGBT. The voltage stabilizing element D0 may be a diode, and the feedback element C0 may be an electrolytic capacitor. In the embodiment, an example that the switching element Q0 is the MOS transistor is taken for illustration, where a gate of the MOS transistor serves as the first connection terminal of the switching element Q0, a drain of the MOS transistor serves as the second connection terminal of the switching element Q0, and a source of the MOS transistor serves as the third connection terminal of the switching element Q0. An anode of the diode serves as the first terminal of the voltage stabilizing element D0, and a cathode of the diode serves as the second terminal of the voltage stabilizing element D0. An anode of the electrolytic capacitor serves as the first terminal of the feedback element C0, and a cathode of the electrolytic capacitor serves as the second terminal of the feedback element C0.

In the embodiment of the present disclosure, the signal supply module 60 is configured to supply a sawtooth signal with a preset frequency, e.g., a 200 kHz sawtooth signal, to the pulse width controller PWM.

In the embodiment of the present disclosure, the rectifier bridge is connected in parallel with the MOS transistor Q0 (where a cathode of the rectifier bridge is connected to the drain of the MOS transistor Q0, and an anode of the rectifier bridge is connected to the source of the MOS transistor Q0 and is grounded). The MOS transistor Q0, the diode D0 and the electrolytic capacitor C0 are connected in series, where the drain of the MOS transistor Q0 is connected to the anode of the diode D0, and the cathode of the diode D0 is connected to the anode of the electrolytic capacitor. The electrolytic capacitor C0 is connected in parallel with the load resistor R0 to output a direct-current voltage Vout. The direct-current voltage Vout is outputted from the cathode of the diode D0 and inputted to the electrolytic capacitor C0. The gate of the MOS transistor Q0 is controlled by the pulse width controller PWM. The pulse width controller PWM outputs the pulse-width signal by comparing the sawtooth signal with a preset frequency with a feedback signal of the direct-current voltage Vout, where the feedback signal of the outputted direct-current voltage Vout is represented by a voltage difference function between a transient voltage on the electrolytic capacitor C0 and a rated threshold, and is a positive voltage signal.

In an embodiment of the present disclosure, the pulse width controller PWM is configured to increase the duty ratio of the pulse-width signal outputted from the pulse width controller PWM if a voltage outputted from the feedback element C0 is greater than a rated voltage threshold, or decrease the duty ratio of the pulse-width signal outputted from the pulse width controller PWM if the voltage outputted from the feedback element C0 is less than the rated voltage threshold.

It should be noted that the pulse width controller PWM may be configured to modulate the pulse width of the current outputted from the diode D0. If the duty ratio of the pulse-width signal outputted from the pulse width controller PWM is increased, a duration for which the MOS transistor Q0 is switched on increases and the pulse width of the current of the diode D0 decreases, that is, an average current outputted from the diode D0 decreases. Therefore, the outputted direct-current voltage Vout can be stabilized under various conditions of the load 50 by modulating the duty ratio of the pulse-width signal outputted from the pulse width controller PWM. The rated voltage threshold is set according to a requirement of the load, and is not limited herein.

As shown in FIG. 2, in an embodiment of the present disclosure, the electronic high-voltage energy extraction and sampling device includes a current sampling module 70 configured to sample a current at an output end of the high-voltage energy extraction module 20.

It should be noted that the current sampling module 70 is connected to each low-voltage side element 22 and is configured to sample a current outputted from the each low-voltage side element 22, so that the electronic high-voltage energy extraction and sampling device can achieve a voltage sensing function through the current sampled by the current sampling module 70. In the embodiment, the current sampling module 70 includes an alternating-current current sensor.

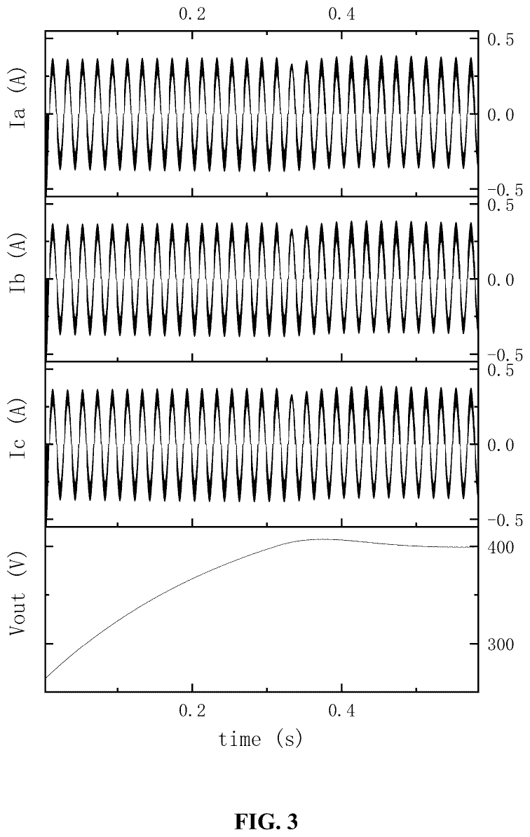

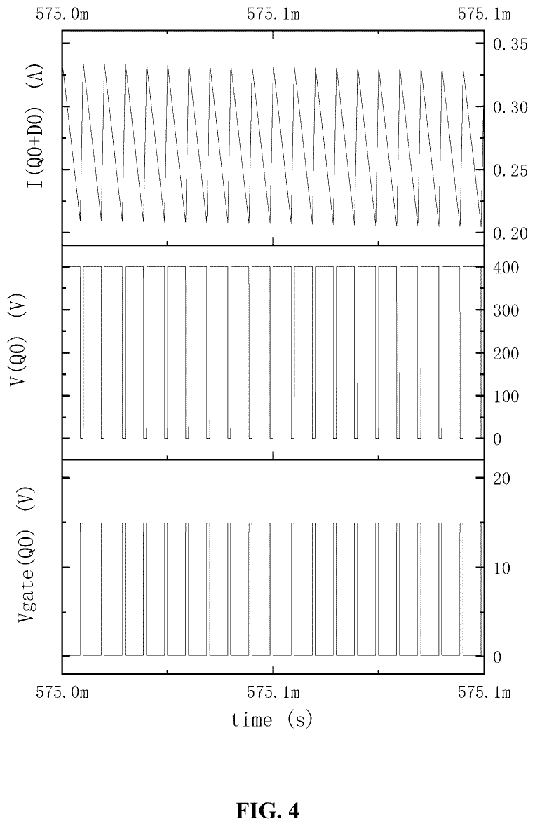

FIG. 3 is a diagram showing startup waveforms of currents of low-voltage inductors and an outputted direct-current voltage Vout in the electronic high-voltage energy extraction and sampling device according to an embodiment of the present disclosure. FIG. 4 is a diagram showing signal waveforms of switching elements in the electronic high-voltage energy extraction and sampling device according to an embodiment of the present disclosure.

In the embodiment of the present disclosure, as shown in FIG. 2, each of voltages of the high-voltage alternating-current sources Ua, Ub, and Uc in the electronic high-voltage energy extraction and sampling device is 10 kV. The high-voltage capacitors C1, C2, and C3 connected to the high-voltage power supply 10 each are set to 100 nF. The low-voltage inductors L1, L2, and L3 each are set to 2 mH. A model of each of the diodes D0 to D6 in the rectifier bridge is determined as MR756 (VRRM=VRWM=VR=600V, VRMS=420V, IO=6.0 A, IFSM=400 A). A model of the MOS transistor Q0 is determined as IRF840 (N-channel power MOSFET, which is able to switch a load up to 500V/8 A). A model of the diode D0 is determined as MR756. The electrolytic capacitor C0 is set to 180 uF, and the load resistor R0 is set to 1.6 kΩ. As shown in FIG. 2 and FIG. 3, under conditions that the direct-current voltage Vout outputted from the electronic high-voltage energy extraction device is 400V and a rated load is 1.6 kΩ, peak values of the currents Ia, Ib, and Ic of the low-voltage inductors each are less than 0.5A. During a startup process of the electronic high-voltage energy extraction device, the direct-current voltage Vout increases linearly and tends to be stable after about 0.5 s with an average value of 400V. As shown in FIG. 2 and FIG. 4, a waveform of current of the switching element Q0 is a sawtooth wave between 0.20 A and 0.35 A, a waveform of a source-drain voltage of the switching element Q0 is a square wave between 0V and 400 V, and a waveform of a signal Vgate for controlling the gate of the switching element Q0 is a square wave between 0V and 15V and is complementary to a waveform of a voltage of the drain of the switching element Q0.

### Second Embodiment

A power supply method by pulse width modulation is further provided according to the present disclosure, and is applied to the electronic high-voltage energy extraction and sampling device described above. The power supply method by pulse width modulation includes:
obtaining a rated voltage threshold required by the load and a voltage outputted from the feedback element;
increasing a duty ratio of a pulse-width signal outputted from the pulse width controller if the voltage outputted from the feedback element is greater than the rated voltage threshold, or decreasing the duty ratio of the pulse-width signal outputted from the pulse width controller if the voltage outputted from the feedback element is less than the rated voltage threshold; and
modulating a pulse width of current outputted from the voltage stabilizing element based on the duty ratio of the pulse width-signal, to supply stable direct-current power to the load.

In the embodiment of the present disclosure, the process of modulating the pulse width of the current outputted from the voltage stabilizing element based on the duty ratio of the pulse width-signal includes:
increasing a duration for which the switching element is switched on and decreasing the pulse width of the current outputted from the voltage stabilizing element, i.e., decreasing an average current outputted from the voltage stabilizing element to decrease a voltage of the direct-current power supplied to the load, if the duty ratio of the pulse-width signal outputted from the pulse width controller is increased; and
decreasing the duration for which the switching element is switched on and increasing the pulse width of the current outputted from the voltage stabilizing element, i.e., increasing the average current outputted from the voltage stabilizing element to increase the voltage of the direct-current power supplied to the load, if the duty ratio of the pulse-width signal outputted from the pulse width controller is decreased.

It should be noted that details of the power supply method by pulse width modulation in the second embodiment are described in the part related to the stabilization output module in the first embodiment, and thus are not described repeatedly in the second embodiment. In the power supply method by pulse width modulation, the duty ratio of the pulse-width signal outputted from the pulse width controller is increased or decreased based on a comparison of the voltage outputted from the feedback element and the rated voltage threshold, thereby modulating the pulse width of the current outputted from the voltage stabilizing element, so as to supply the stable direct-current power to the load.

### Third Embodiment

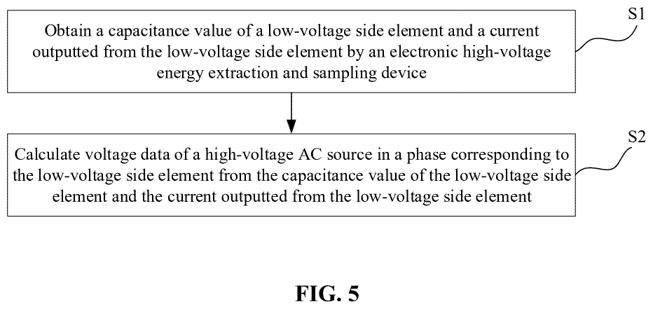

FIG. 5 is a flowchart showing an electronic high-voltage energy extraction and sampling method according to an embodiment of the present disclosure.

An electronic high-voltage energy extraction and sampling method is further provided according to the present disclosure, and includes the following steps S1 and S2.

In step S1, a capacitance value of the low-voltage side element and a current outputted from the low-voltage side element are obtained by the electronic high-voltage energy extraction and sampling device described above.

In step S2, a voltage of a high-voltage alternating-current source in a phase corresponding to the low-voltage side element is calculated from the capacitance value of the low-voltage side element and the current outputted from the low-voltage side element.

In the embodiment, the process of calculating the voltage of the high-voltage alternating-current source in the phase corresponding to the low-voltage side element from the capacitance value of the low-voltage side element and the current outputted from the low-voltage side element includes: calculating the voltage of the high-voltage alternating-current source in the phase corresponding to the low-voltage side element from the capacitance value of the low-voltage side element and the current outputted from the low-voltage side element based on a proportional integral equation.

The proportional integral equation is expressed as U=∫I_{dt}/C, where I represents the current outputted from the low-voltage side element, U represents the voltage of the high-voltage alternating-current source in the phase corresponding to the low-voltage side element, and C represents the capacitance value of the low-voltage side element.

It should be noted that the electronic high-voltage energy extraction and sampling device is described in detail in the first embodiment, and thus is not described repeatedly in the third embodiment. With the electronic high-voltage energy extraction and sampling method, the current sampling module samples a current of each low-voltage side element (such as the low-voltage inductors L1, L2, and L3) to obtain currents Ia, Ib, and Ic. The currents Ia, Ib, and Ic are in respective functions of the high-voltage alternating-current source Ua, Ub, and Uc of three phases. The voltage of the high-voltage alternating-current source in a corresponding phase is obtained by performing proportional integral operation on each of sampling signals of the currents Ia, Ib, and Ic, achieving a high-voltage sensing function. In the embodiment, U=I(R+1/jωC), ω=2πƒ, where R represents an equivalent resistance of the low-voltage arm, f represents a frequency of the high-voltage alternating-current source, j represents an imaginary unit, and j²=−1. R is much less than 1/jωC. Therefore, U=I/jωC is obtained by ignoring R. A simplified differential function for a voltage and a current of the high-voltage alternating-current source of each phase is expressed as I=C∫U/dt. The proportional integral equation is expressed as U=∫Idt/C. That is, the voltage of the high-voltage alternating-current power is obtained by performing an proportional integral operation on the sampled current outputted from the low-voltage side element, where I represents the current outputted from the low-voltage side element, i.e., Ia, Ib, or Ic.

Those skilled in the art may clearly understand that, for convenience and brevity of description, for a detailed operation process of the foregoing system, device and unit, reference may be made to a corresponding process in the foregoing embodiments of the method, which is not repeated herein.

In some embodiments according to the present disclosure, it should be understood that the disclosed system, device and method may be implemented in other forms. For example, the embodiments of the device described above are only schematic. For example, the division of the units is only a logical functional division, and there may be other division methods in actual implementation. For example, multiple units or components may be combined or integrated into another system, or some features may be ignored or not be executed. On the other hand, the coupling or direct coupling or communication connection between each other shown or discussed may be implemented via some interfaces, the indirect coupling or the communication connection of devices or units may be electrical, mechanical or other forms.

The above unit described as a separate component may be or may be not separated physically. The component displayed as a unit may be or may be not a physical unit, that is, may be located at one place or may be distributed on multiple network units. Some or all of the units may be adopted based on an actual need to achieve the objective of the solutions in the embodiments of the present disclosure.

In addition, all function units according to the embodiment of the present disclosure may be integrated into one processing unit, or may be a physically separate unit, or two or more units are integrated into one unit. The foregoing integrated unit may be implemented in a form of hardware or a software functional unit.

In a case that the integrated unit is implemented in the form of the software functional unit and sold or used as an independent product, the integrated unit may be stored in a computer-readable storage medium. Based on such understanding, the essence of the technical solutions of the present disclosure, or parts of the technical solutions which contribute to the conventional technology or all or parts of the technical solutions may be embodied in a form of a software product. The computer software product is stored in a storage medium, and includes several instructions which enable a computer device (such as a personal computer, a server, or a network device) to perform all or part of the method according to the embodiments of the present disclosure. The foregoing storage medium includes a U disk, a removable hard disk, a read-only memory (ROM), a random-access memory (RAM), a magnetic disk, an optical disk, or other media that can store program codes.

In summary, the above embodiments are only for illustrating the technical solutions of the present disclosure, and are not intended to limit the present disclosure. Although the present disclosure is illustrated in detail with reference to the embodiments described above, it should be understood by those skilled in the art that modification can be made to the technical solutions recited in the embodiments described above, or equivalent substitution can be made onto a part of technical features of the technical solution. The modifications and equivalent replacements do not make the corresponding technical solutions deviate from the scope of the technical solutions of the embodiments of the present disclosure.

1. An electronic high-voltage energy extraction and sampling device, comprising:
a high-voltage power supply;
a high-voltage energy extraction module, connected to the high-voltage power supply;
a rectification module, connected to the high-voltage energy extraction module; and
a stabilization output module, connected to the rectification module,
wherein the stabilization output module is connected to a load, and the high-voltage energy extraction module comprises a high-voltage side element and a low-voltage side element,
the high-voltage power supply is configured to provide a high-voltage alternating-current source;
the high-voltage side element is connected in series with the high-voltage power supply to form a high-voltage arm;
the low-voltage side element is connected in series with the high-voltage side element to form a low-voltage arm;
the rectification module is connected to the low-voltage side element, and is configured to rectify power outputted from the low-voltage side element; and
the stabilization output module is configured to supply stable direct-current power to the load.

2. The electronic high-voltage energy extraction and sampling device according to claim 1, wherein the stabilization output module comprises:
a switching element, comprising a first connection terminal, a second connection terminal, and a third connection terminal;
a voltage stabilizing element;
a feedback element; and
a pulse width controller, wherein
the first connection terminal and the second connection terminal of the switching element are connected in parallel with an output end of the rectification module, the third connection terminal of the switching element is connected to an output terminal of the pulse width controller, and the first connection terminal of the switching element is further connected to a first terminal of the voltage stabilizing element;
a second terminal of the voltage stabilizing element is connected to a first terminal of the feedback element, a first input terminal of the pulse width controller and the load, and a second terminal of the feedback element is grounded; and
a second input terminal of the pulse width controller is connected to a signal supply module, and the pulse width controller is configured to modulate a pulse width of current outputted from the voltage stabilizing element based on a duty ratio of a pulse-width signal outputted from the pulse width controller, to supply the stable direct-current power to the load.

3. The electronic high-voltage energy extraction and sampling device according to claim 2, wherein the pulse width controller is configured to:
increase the duty ratio of the pulse-width signal outputted from the pulse width controller if a voltage outputted from the feedback element is greater than a rated voltage threshold; or
decrease the duty ratio of the pulse-width signal outputted from the pulse width controller if the voltage outputted from the feedback element is less than the rated voltage threshold.

4. The electronic high-voltage energy extraction and sampling device according to claim 1, wherein the high-voltage energy extraction module is connected to a connection terminal of the high-voltage alternating-current source of each phase provided by the high-voltage power supply.

5. The electronic high-voltage energy extraction and sampling device according to claim 1, comprising a current sampling module, configured to sample a current at an output end of the high-voltage energy extraction module.

6. The electronic high-voltage energy extraction and sampling device according to claim 1, wherein the high-voltage side element comprises a high-voltage capacitor and the low-voltage side element comprises a low-voltage inductor.

7. A power supply method by pulse width modulation, applied to the electronic high-voltage energy extraction and sampling device according to claim 2, wherein the power supply method by pulse width modulation comprises:
obtaining a rated voltage threshold required by the load and a voltage outputted from the feedback element;
increasing the duty ratio of the pulse-width signal outputted from the pulse width controller if the voltage outputted from the feedback element is greater than the rated voltage threshold, or decreasing the duty ratio of the pulse-width signal outputted from the pulse width controller if the voltage outputted from the feedback element is less than the rated voltage threshold; and
modulating a pulse width of current outputted from the voltage stabilizing element based on the duty ratio of the pulse width-signal, to supply stable direct-current power to the load.

8. The power supply method by pulse width modulation according to claim 7, wherein the modulating a pulse width of current outputted from the voltage stabilizing element based on the duty ratio of the pulse width-signal comprises:
increasing a duration for which the switching element is switched on and decreasing the pulse width of the current outputted from the voltage stabilizing element, i.e., decreasing an average current outputted from the voltage stabilizing element to decrease a voltage of the direct-current power supplied to the load, if the duty ratio of the pulse-width signal outputted from the pulse width controller is increased; and
decreasing the duration for which the switching element is switched on and increasing the pulse width of the current outputted from the voltage stabilizing element, i.e., increasing the average current outputted from the voltage stabilizing element to increase the voltage of the direct-current power supplied to the load, if the duty ratio of the pulse-width signal outputted from the pulse width controller is decreased.

9. An electronic high-voltage energy extraction and sampling method, comprising:
obtaining, by the electronic high-voltage energy extraction and sampling device according to any claim 1, a capacitance value of the low-voltage side element and a current outputted from the low-voltage side element; and
calculating a voltage of a high-voltage alternating-current source in a phase corresponding to the low-voltage side element from the capacitance value of the low-voltage side element and the current outputted from the low-voltage side element.

10. The electronic high-voltage energy extraction and sampling method according to claim 9, wherein the calculating a voltage of a high-voltage alternating-current source in a phase corresponding to the low-voltage side element from the capacitance value of the low-voltage side element and the current outputted from the low-voltage side element comprises:
calculating the voltage of the high-voltage alternating-current source in the phase corresponding to the low-voltage side element from the capacitance value of the low-voltage side element and the current outputted from the low-voltage side element based on a proportional integral equation,
wherein the proportional integral equation is expressed as:
$$U = \int {I}_{d t} / C$$
wherein I represents the current outputted from the low-voltage side element, U represents the voltage of the high-voltage alternating-current source in the phase corresponding to the low-voltage side element, and C represents the capacitance value of the low-voltage side element.
